(19) United States
(12) Patent Application Publication
(10) Pub. No.: US 2019/0230409 A1
(43) Pub. Date: Jul. 25, 2019

(54) PICTURE-IN-PICTURE BASE VIDEO STREAMING FOR MOBILE DEVICES

(71) Applicant: Livelike Inc., New York, NY (US)

(72) Inventors: Saswat Panda, Brooklyn, NY (US); Fabrice David Ferenç Lorenceau, Issy-Les-Moulineaux (FR)

(21) Appl. No.: 16/371,439

(22) Filed: Apr. 1, 2019

Related U.S. Application Data
(63) Continuation of application No. PCT/US17/55184, filed on Oct. 4, 2017.
(60) Provisional application No. 62/404,044, filed on Oct. 4, 2016.

(51) Int. Cl. H04N 21/44; H04N 21/414; H04N 21/2365; H04N 21/442; H04N 21/81; H04N 21/431

(52) U.S. Cl. CPC H04N 21/44016; H04N 21/41407; H04N 21/4316; H04N 21/44218; H04N 21/816; H04N 21/2365

(57) ABSTRACT

Picture-in-picture based video streaming for mobile devices is provided. In various embodiments, unitary video stream is received at a mobile device. The unitary video stream encodes a video. The video has a plurality of non-overlapping regions. Each of the non-overlapping regions of the video is displayed in a virtual environment. Each of the non-overlapping regions of the video are displayed in discontinuous locations within the virtual environment.

### CROSS-REFERENCE TO RELATED APPLICATIONS

This application is a continuation of International Application No. PCT/US17/55184, filed Oct. 4, 2017, which claims priority to U.S. Provisional Application No. 62/404,044, filed Oct. 4, 2016, which are hereby incorporated by reference in their entireties.

### BACKGROUND

Embodiments of the present invention relate to video streaming, and more specifically, to picture-in-picture based video streaming for mobile devices.

### BRIEF SUMMARY

According to embodiments of the present disclosure, methods of and computer program products for video streaming are provided. A unitary video stream is received at a mobile device. The unitary video stream encodes a video. The video has a plurality of non-overlapping regions. Each of the non-overlapping regions of the video is displayed in a virtual environment. Each of the non-overlapping regions of the video are displayed in discontinuous locations within the virtual environment.

In some embodiments, the video stream is decoded using a hardware decoder to obtain the video. In some embodiments, the discontinuous locations are surfaces within the virtual environment. In some embodiments, the discontinuous locations are determined by reading metadata of the video stream. In some embodiments, the metadata comprises a geometric description of each of the non-overlapping regions.

In some embodiments, a user's gaze is tracked within a first of the non-overlapping regions. A second of the plurality of non-overlapping regions is updated based on the user's attention. In some embodiments, event metadata is read. A second of the plurality of non-overlapping regions is updated based on the event metadata. In some embodiments, motion is detected within a first of the non-overlapping regions. A second of the plurality of non-overlapping regions is updated based on the detected motion. In some embodiments, updating comprises generating an enlarged version of the first of the non-overlapping regions. In some embodiments, updating comprises selecting an alternative video stream of the first region.

In additional embodiments, methods of and computer program products for video streaming are provided. A plurality of source video streams are received at a server. The plurality of video streams is combined into a unitary video stream encoding a video. Each of the source video streams occupy a non-overlapping region of the video. The unitary video stream is sent to a mobile device. The mobile device is adapted to receive the unitary video stream and display each of the non-overlapping regions of the video in a virtual environment, each of the non-overlapping regions of the video being displayed in discontinuous locations within the virtual environment.

In some embodiments, the mobile device is further adapted to decode the video stream using a hardware decoder to obtain the video. In some embodiments, the discontinuous locations are surfaces within the virtual environment. In some embodiments, the discontinuous locations are determined by reading metadata of the video stream. In some embodiments, the metadata comprises a geometric description of each of the non-overlapping regions.

In some embodiments, a user's gaze is tracked within a first of the non-overlapping regions. In some embodiments, video streams are selected for inclusion in the unitary video stream based on the user's attention. In some embodiments, an enlarged version of the first of the non-overlapping regions is generated for inclusion in the unitary video stream.

In some embodiments, event metadata is read. Video streams are selected for inclusion in the unitary video stream based on the event metadata. In some embodiments, motion is detected within a first of the non-overlapping regions. Video streams are selected for inclusion in the unitary video stream based on the detected motion.

### BRIEF DESCRIPTION OF THE SEVERAL VIEWS OF THE DRAWINGS

FIGS. 1A-B depict an exemplary virtual environment according to embodiments of the present disclosure.

FIGS. 2A-B depict a second exemplary virtual environment according to embodiments of the present disclosure.

FIG. 3 illustrates a method of video streaming according to embodiments of the present disclosure.

FIG. 4 illustrates another method of video streaming according to embodiments of the present disclosure.

FIG. 5 depicts a computing node according to an embodiment of the present invention.

### DETAILED DESCRIPTION

Current generation of mobile devices, as well as PCs, have a limitation on the number of videos that can be played back at the same time. For example, even cutting-edge phones have a single hardware decoder for video playback. Thus, a first video is played using dedicated video playback hardware. However, if a second video is played simultaneously on the same device, that video needs to be decoded on the CPU. Decoding on the CPU entails a significant performance hit as compared to a hardware decoder. Furthermore, playing a third concurrent video is not practical without specialized hardware not available on a mobile device. Moreover, the performance degradation of playing multiple videos at the same time is particularly problematic in VR, where frame rate is critical to the immersive quality of the virtual environment.

According to various embodiments of the present disclosure, a composite video stream is provided. Rather than streaming multiple videos concurrently to build a scene, a single video is prepared that has additional other videos embedded in it. The embedded videos may be reused on different surfaces within a virtual scene. In various embodiments, the virtual scene may include virtual reality (VR) augmented reality (AR). Upon receipt of the composite video, the video is decoded. Each frame of the decoded video is cut into multiple regions. The sequence of frames in each region makes up the embedded videos. Each embedded video may then be displayed wherever desired within a scene. In addition, each embedded video may be composited with the other videos in arrangements determined at the client-side. For example, a user may control which nested videos are displayed in a scene.

This approach enables a wide range of functionality in an interactive environment. In a VR scene, a user may preview other camera angles before jumping to them by viewing a nested thumbnail preview of a video. In addition, video of multiple events may be viewed concurrently. For example, while viewing a tennis tournament within a VR environment, one or more virtual screens may be provided within the scene, each showing live footage from other courts or other events. Advertising videos may be included in a scene as well, displayed on virtual screens or otherwise selectively embedded in the scene.

Similarly, replays may be included concurrently in the video stream for instant viewing. For example, a given replay can run as a continuous loop. For example, each goal is a small video loop inside a section of the composite video. The replay would then be viewable immediately by selecting something in the interface, or otherwise interacting with the virtual environment.

It will be appreciated that a variety of virtual and augmented reality devices are known in the art. For example, various head-mounted displays providing either immersive video or video overlays are provided by various vendors. Some such devices integrate a smart phone within a headset, the smart phone providing computing and wireless communication resources for each virtual or augmented reality application. Some such devices connect via wired or wireless connection to an external computing node such as a personal computer. Yet other devices may include an integrated computing node, providing some or all of the computing and connectivity required for a given application.

Virtual or augmented reality displays may be coupled with a variety of motion sensors in order to track a user's motion within a virtual environment. Such motion tracking may be used to navigate within a virtual environment, to manipulate a user's avatar in the virtual environment, or to interact with other objects in the virtual environment. In some devices that integrate a smartphone, head tracking may be provided by sensors integrated in the smartphone, such as an orientation sensor, gyroscope, accelerometer, or geomagnetic field sensor. Sensors may be integrated in a headset, or may be held by a user, or attached to various body parts to provide detailed information on user positioning.

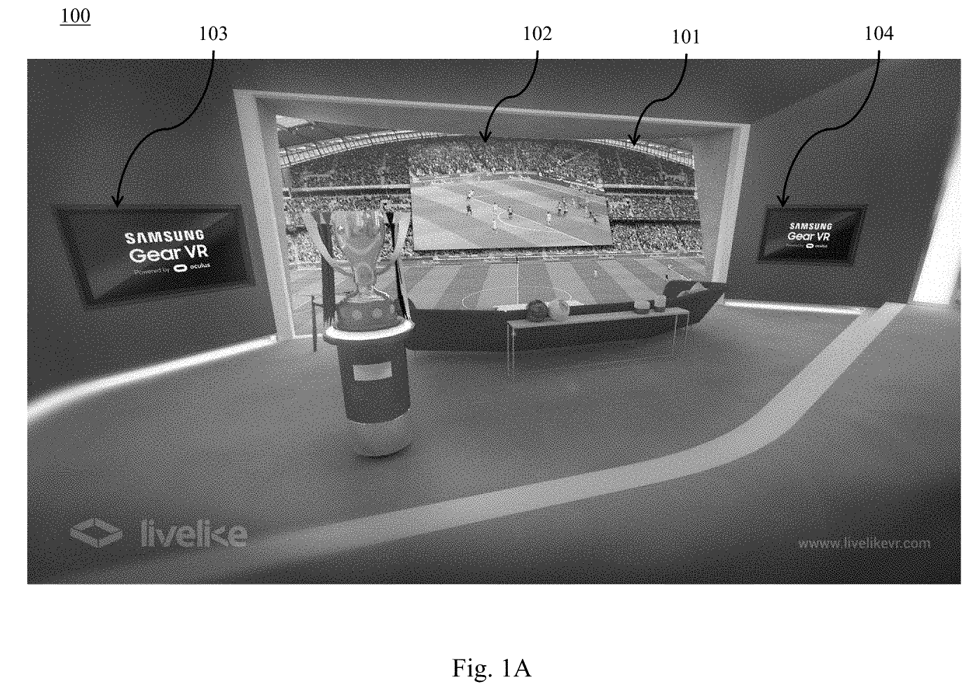

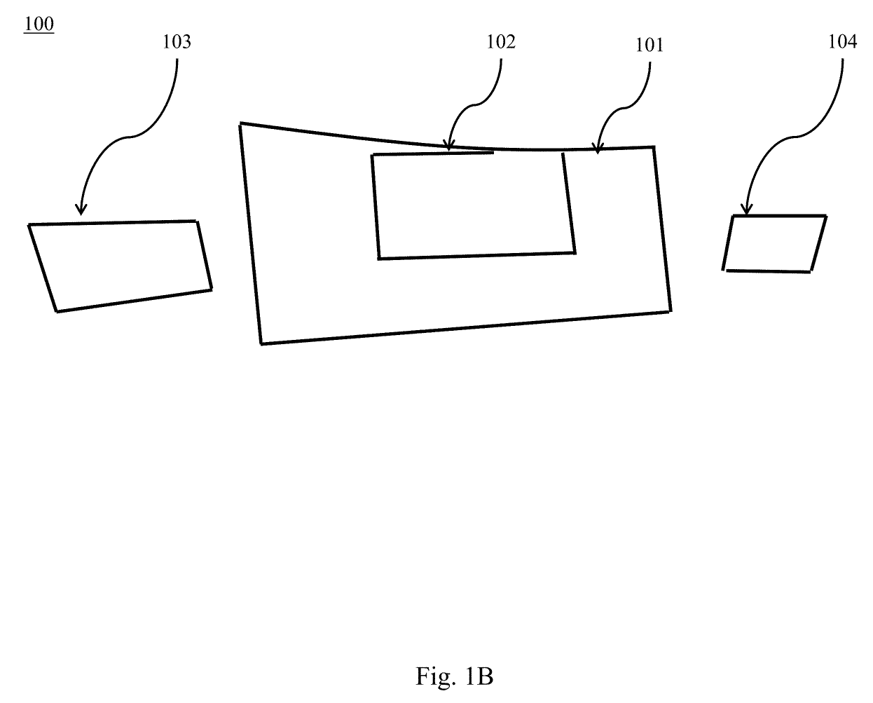

With reference now to FIG. 1A, an exemplary virtual environment 100 is depicted. A main video is displayed on main screen 101. Additional screens 102 . . . 104 are also included in the virtual environment. According to various embodiments, each of the videos displayed on the screens 101 . . . 104 are included in individual regions of a single video stream and are split up at the device side and displayed on the various screens in the virtual environment. In FIG. 1B, each video region is depicted without the surrounding virtual environment for clarity.

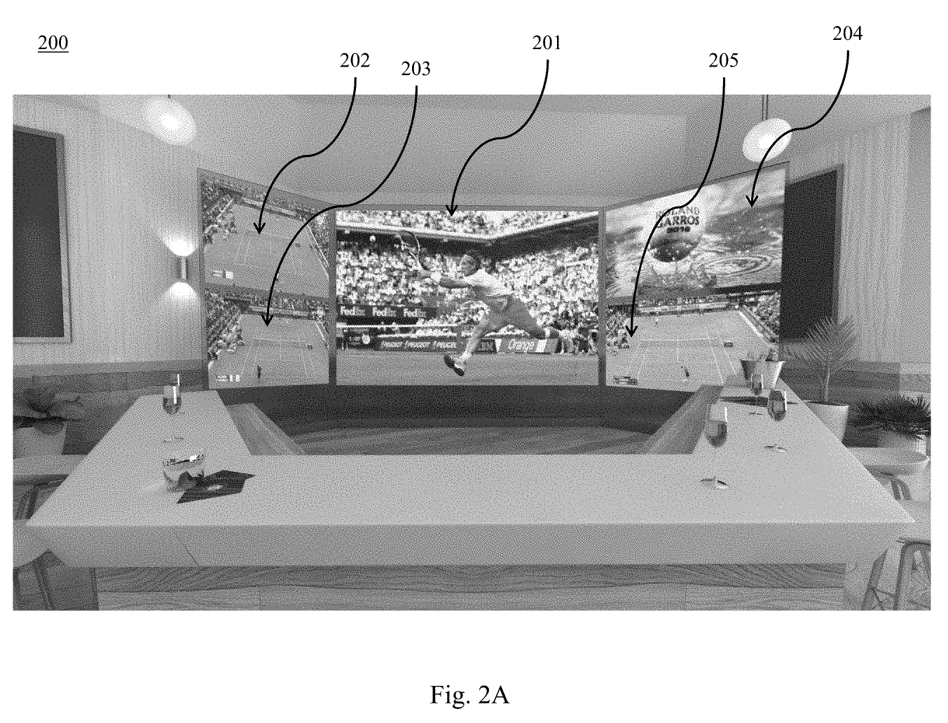

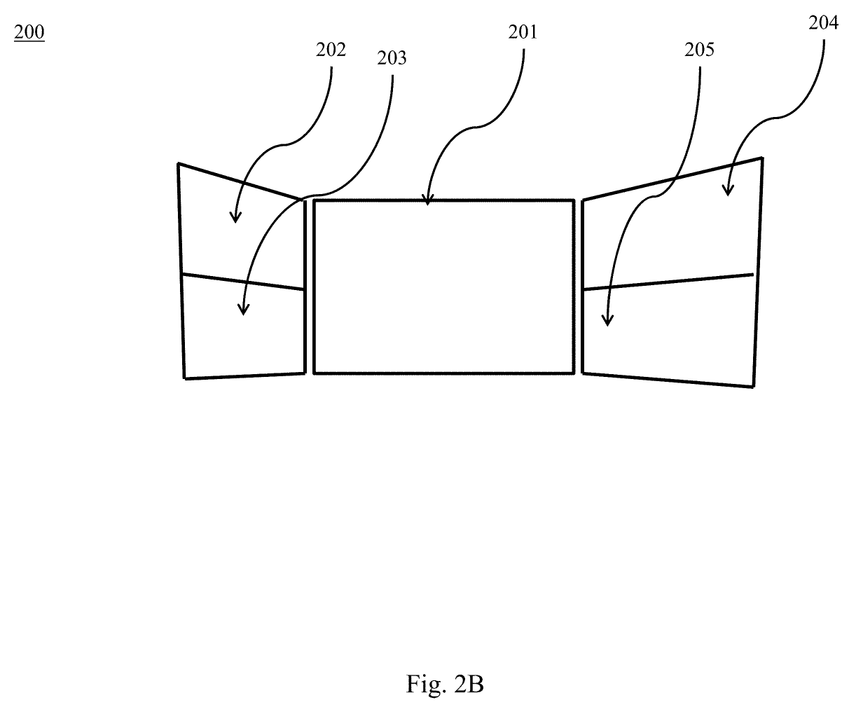

With reference now to FIG. 2A, a second exemplary virtual environment 200 is depicted. Within the environment, multiple virtual screens 201 . . . 205 are rendered. For example, each of screens 201 . . . 205 can contain an ad, a replay loop, an alternative camera angle, or even un unrelated video stream such as from another game. In FIG. 2B, each video region is depicted without the surrounding virtual environment for clarity.

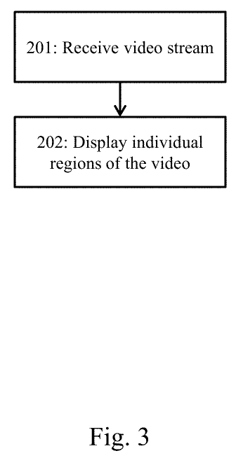

Referring now to FIG. 3, a method of video streaming according to embodiments of the present disclosure is illustrated. At 201, a unitary video stream is received at a mobile device. In some embodiments, the unitary video stream encodes a video. In some embodiments, the video has a plurality of non-overlapping regions. At 202, each of the non-overlapping regions of the video is displayed in a virtual environment. In some embodiments, each of the non-overlapping regions of the video are displayed in discontinuous locations within the virtual environment.

In some embodiments, each of the non-overlapping regions of the video are determined by reading metadata of the video stream. For example, metadata may describe the geometry of each region relative to the overall video frame. In a simple example, the frame may be divided into quarters. In some embodiments, the metadata is provided as header information embedded in the stream.

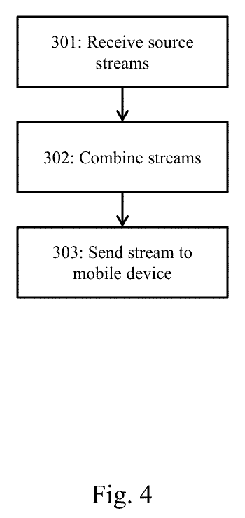

Referring now to FIG. 4, a method of video streaming according to embodiments of the present disclosure is illustrated. At 301, a plurality of source video streams are received at a server. At 302, the plurality of video streams is combined into a unitary video stream encoding a video. Each of the source video streams occupy a non-overlapping region of the video. In some embodiments, metadata determining the locations within each frame of each constituent is generated for inclusion in the data stream. At 303, the unitary video stream is sent to a mobile device. The mobile device is adapted to receive the unitary video stream and display each of the non-overlapping regions of the video in a virtual environment, each of the non-overlapping regions of the video being displayed in discontinuous locations within the virtual environment.

In some embodiments, the constituent streams are selected on the basis of data regarding a primary stream. For example, where a primary stream includes a primary camera angle of a sporting event, secondary streams may be dynamically selected based on the locations of motions with in the frame. So, an appropriate alternate camera angle may be included with the composite stream to capture the locations of most interest. Similarly, in embodiments where a metadata stream or live data track is available, constituent streams may be selected based on that metadata. For example, if the metadata stream indicates that a goal was made, a loop may be dynamically generated of that moment of goal, and that loop may be included in the composite stream. Similarly, an enlarged version of a source stream may be included in the composite stream when an event of interest is displayed therein.

User attention may also drive the selection of constituent streams in some embodiments. For example, where eye tracking or gaze tracking indicates that a user has focused on a given area of a first video, an enlarged version of that area may be presented in a second constituent video. In this way, a secondary virtual display can be responsive to a user's interaction with a primary virtual display. It will be appreciated that the above is applicable to virtual and augmented reality environments in general, including those that are presented without a headset. For example, a magic window implementation of VR or AR uses the display on a handheld device such as a phone as a window into a virtual space. By moving the handheld, by swiping, or by otherwise interacting with the handheld device, the user shifts the field of view of the screen within the virtual environment. A center of a user's field of view can be determined based on the orientation of the virtual window within the virtual space without the need for eye-tracking. However, in devices including eye-tracking, more precision may be obtained.

In some embodiments, a main video area and several smaller video areas are provided in a virtual environment. The main area provides an immersive view, for example, of a stadium to watch the sporting event as if the viewer were there. That view may be distorted because a wide angle fisheye lens is used. The fisheye distortion is unwrapped by playing the video on a hemispheric meshed player (e.g., Projection-Mapping). For more immersion when other videos are placed, the characteristics of the primary feed may be applied. For example, the same projection mapping distortion may be applied to the secondary feeds so that they look like they are in the same 3D scene and blend seamlessly.

In addition to lens data, surface detection may also be used to better place and orient the smaller videos within the primary video. Augmented Reality data such as surface detection and lens data may be used to merge multiple videos from the composite video stream into a new scene where video are interactive elements. Using this approach, these video remain separate and the Augmented Reality compositing may be performed on the user device. This avoids compositing multiple videos into a 3D scene at the server side, and thus allows sub-videos to react.

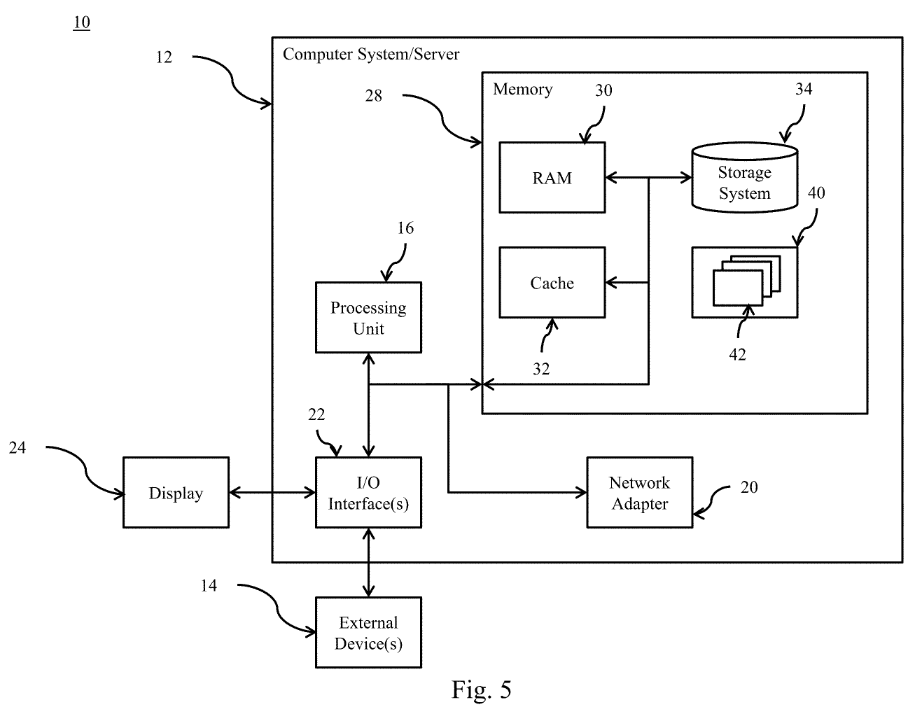

Referring now to FIG. 5, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove. [0031] In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving at a mobile device a unitary video stream, the unitary video stream encoding a video, the video having a plurality of non-overlapping regions;
displaying each of the non-overlapping regions of the video in a virtual environment, each of the non-overlapping regions of the video being displayed in discontinuous locations within the virtual environment.

2. The method of claim 1, further comprising decoding the video stream using a hardware decoder to obtain the video.

3. The method of claim 1, wherein the discontinuous locations are surfaces within the virtual environment.

4. The method of claim 1, wherein the discontinuous locations are determined by reading metadata of the video stream.

5. The method of claim 4, wherein the metadata comprises a geometric description of each of the non-overlapping regions.

6. The method of claim 1, further comprising:
tracking a user's gaze within a first of the non-overlapping regions;
updating a second of the plurality of non-overlapping regions based on the user's gaze.

7. The method of claim 1, further comprising:
reading event metadata;
updating a second of the plurality of non-overlapping regions based on the event metadata.

8. The method of claim 1, further comprising:
detecting motion within a first of the non-overlapping regions;
updating a second of the plurality of non-overlapping regions based on the detected motion.

9. The method of claim 6, wherein the updating comprises generating an enlarged version of the first of the non-overlapping regions.

10. A method comprising:
receiving at a server a plurality of source video streams;
combining the plurality of video streams into a unitary video stream encoding a video, each of the source video streams occupying a non-overlapping region of the video;
sending the unitary video stream to a mobile device, the mobile device being adapted to:
receive the unitary video stream; and
display each of the non-overlapping regions of the video in a virtual environment, each of the non-overlapping regions of the video being displayed in discontinuous locations within the virtual environment.

11. The method of claim 10, the mobile device being further adapted to decode the video stream using a hardware decoder to obtain the video.

12. The method of claim 10, wherein the discontinuous locations are surfaces within the virtual environment.

13. The method of claim 10, wherein the discontinuous locations are determined by reading metadata of the video stream.

14. The method of claim 13, wherein the metadata comprises a geometric description of each of the non-overlapping regions.

15. The method of claim 10, further comprising:
tracking a user's gaze within a first of the non-overlapping regions;
selecting among the plurality of source video streams for inclusion in the unitary video stream based on the user's attention.

16. The method of claim 15, further comprising:
tracking a user's gaze within a first of the non-overlapping regions;
generating an enlarged version of the first of the non-overlapping regions for inclusion in the unitary video stream.

17. The method of claim 10, further comprising:
reading event metadata;
selecting among the plurality of source video streams for inclusion in the unitary video stream based on the event metadata.

18. The method of claim 10, further comprising:
detecting motion within a first of the non-overlapping regions;
selecting among the plurality of source video streams for inclusion in the unitary video stream based on the detected motion.

19. A computer program product for video streaming, the computer program product comprising a computer readable storage medium having program instructions embodied therewith, the program instructions executable by a processor to cause the processor to perform a method comprising:
receiving at a mobile device a unitary video stream, the unitary video stream encoding a video, the video having a plurality of non-overlapping regions;
displaying each of the non-overlapping regions of the video in a virtual environment, each of the non-overlapping regions of the video being displayed in discontinuous locations within the virtual environment.

20. The computer program product of claim 19, the method further comprising further comprising decoding the video stream using a hardware decoder to obtain the video.

21. The computer program product of claim 19, wherein the discontinuous locations are surfaces within the virtual environment.

22. The computer program product of claim 19, wherein the discontinuous locations are determined by reading metadata of the video stream.

23. The computer program product of claim 22, wherein the metadata comprises a geometric description of each of the non-overlapping regions.

24. The computer program product of claim 19, the method further comprising:
tracking a user's gaze within a first of the non-overlapping regions;
updating a second of the plurality of non-overlapping regions based on the user's gaze.

25. The computer program product of claim 24, wherein the updating comprises generating an enlarged version of the first of the non-overlapping regions.

26. The computer program product of claim 19, the method further comprising:
reading event metadata;
updating a second of the plurality of non-overlapping regions based on the event metadata.

27. The computer program product of claim 19, the method further comprising:
detecting motion within a first of the non-overlapping regions;
updating a second of the plurality of non-overlapping regions based on the detected motion.
